(19) United States
(12) Patent Application Publication
(10) Pub. No.: US 2003/0011449 A1
(43) Pub. Date: Jan. 16, 2003

(54) Transmission line windows

(76) Inventor: Barry George Morton Helme, Liskeard (GB)

Correspondence Address: Ira S Dorman, Suite 200, 330 Roberts Street, East Hartford, CT, 06108, US

(21) Appl. No.: 10/169,810

(22) PCT Filed: Oct. 15, 2001
(86) PCT No.: PCT/GB01/04576

(30) Foreign Application Priority Data
Oct. 16, 2000 (GB) 00 25 289.0

(51) Int. Cl. H01P 1/08

(52) U.S. Cl. 333/252

(57) ABSTRACT

A window assembly for use with electromagnetic waveguides includes a window 3 and a housing 4. The window 3 has impermeable layers 33 and 34 which are bridged by a reticulum 35 of ceramic material with internal spaces which form a continuous flow path for coolant. The window is received in an opening in the housing 4 which is surrounded by an inwardly-directed flange having a peripheral recess opposed to the window 3 to improve the microwave performance of the window.

### TECHNICAL FIELD OF THE INVENTION

This invention relates to windows of the kind which serve to isolate the environment within a section of electromagnetic transmission line from another environment of different pressure and/or other environmental conditions, and which allow electromagnetic energy travelling along the transmission line to pass through the window with little or no loss of power.

### BACKGROUND

In the r.f., microwave and millimeter wave regions of the spectrum, electromagnetic energy is often transmitted via coaxial, triaxial or hollow metal waveguide transmission lines. In many civil or military applications very high powers are required to be transmitted by these means, e.g. for the transmission of high power signals to the antenna of a communication or radar system or to supply r.f. or microwave power to industrial microwave ovens or for nuclear fusion or plasma experiments.

As the power in the transmission line is increased the associated electric field also increases, and at a certain power level the electric field becomes so great that the gas in the transmission line ionises resulting in the generation of a spark. However the power handling capability of the transmission line can be increased by using certain gases at high pressures. For example, the power handling capability of a hollow rectangular waveguide can be increased seventeen fold by using SF₆ at two atmospheres.

When the transmission line is thus pressurised there must usually be an r.f. or microwave transparent means of holding the pressure provided at each end of the transmission line. These are referred to as pressure windows.

At the current state of the art, pressure windows used either as low pressure or high pressure barriers can withstand r.f. or microwave powers up to the point where the window becomes too absorbent of the r.f. or microwaves so that the window no longer performs its required function of being transparent to the r.f. or microwave energy. The window may also reach the point where it becomes damaged due to excessive heating. All materials tend to warm up as they are subjected to r.f. or microwave power and many of the low loss materials which are suitable for pressure windows exhibit an increased absorption of r.f. or microwave power as they heat up. This can lead to a thermal runaway effect, if not restricted.

Further problems result from the fact that window materials are non-conducting dielectrics. The high electric fields which are generated at high powers cause electrons to be stripped off the window material resulting in severe erosion damage to the window surface. This in turn increases the susceptibility of the window to further erosion and increases power absorption in the window reducing its power handling capabilities. Eventually a discharge pathway may be established in the window which, if a discharge is allowed to occur, may ultimately destroy the window. In order to minimise these potential problems transmission line windows are provided with suitable cooling at high powers. This may be achieved in two ways.

Firstly, a cooling jacket may be included in the outer wall of the transmission line, to which the window is thermally bonded. However, this relies on the ability of the window to conduct heat from its central area to the cooler outer areas, and gives rise to temperature gradients which can cause stresses in the window and increased likelihood of failure.

A better method employs two plates of window material axially spaced along the transmission line. Coolant material is passed between the two plates so that the window is cooled across its total area, but since the thickness of the window is effectively doubled the r.f. or microwave power loss is effectively doubled compared with a single thickness window.

The two window plates may contain surface grooves to aid the flow of coolant and increase the surface area in contact with the coolant, but they are susceptible to bursting forces resulting from the pressurised circulation of coolant.

An aim of the present invention may be viewed as being to provide a form of transmission line window which has low thermal stress across the window yet employs more efficient cooling so that the r.f. and microwave absorption of the window is reduced compared with a double plate window, and in which the ability of the window to carry microwave or r.f. power is substantially increased.

### SUMMARY OF THE INVENTION

The present invention proposes a transmission line window having a pair of opposed window surfaces through which the electromagnetic energy passes in use, characterised by a pair of mutually spaced impermeable layers between which there is a flow path for a liquid or gaseous coolant, and in which bridging material extends between the impermeable layers in the coolant flow path in regions of the window which are disposed between the said window surfaces.

In the context of this patent specification the term “impermeable” is intended to mean that under normal operating conditions the respective layer does not, for all practical purposes, afford passage of either the media which the window is required to separate, or of the coolant fluid. It is conceivable that the layers could be permeable to other materials, or to the same materials under extreme operating conditions, but that is of no relevance in the present context.

It is envisaged that the main use of the window is in retaining a pressurised medium within a transmission line, but if a suitable application arose the window could also be used between environments or equal pressure, or to maintain a low pressure or an effective vacuum within a transmission line.

It is possible that within the scope of the present invention the bridging material could be sandwiched between the outer layers without actually being connected thereto, but usually the bridging material will be joined to the impermeable layers for optimum strength and enhanced cooling efficiency. For the same reasons, although the outer layers could be bonded to the bridging material, the bridging material is preferably integrally formed with the impermeable layers.

Although the bridging material could take various forms within the scope of the invention, the bridging material preferably comprises a solid reticulum containing numerous mutually interconnected internal spaces which are comprised in the flow path. The surface area of the window material which is bathed in the coolant is thereby optimised, resulting in optimum cooling efficiency.

The reticulum is preferably formed of a ceramic material.

### BRIEF DESCRIPTION OF THE DRAWINGS

The invention is exemplified in the accompanying drawings, in which:

FIG. 1 is a general exploded view of transmission line window assembly of the invention;

FIG. 2 shows, in perspective, just the window portion of the assembly;

FIG. 3 is a transverse section through the window of FIG. 2;

FIG. 4 is a magnified view of the internal microstructure of the window;

FIG. 5 is a general exploded view of a preferred form of transmission line window assembly; and

FIG. 6 is a section through one side of the assembly.

### DETAILED DESCRIPTION OF THE DRAWINGS

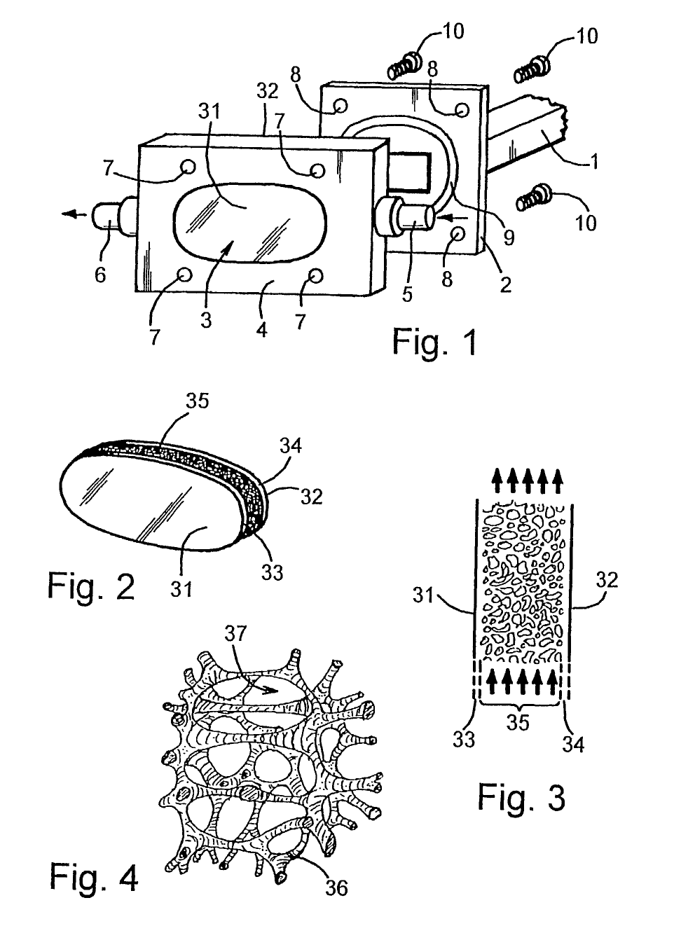

Referring firstly to the general view of FIG. 1, a pressurised section of tubular waveguide 1, which may be of any convenient cross-sectional shape, is joined in known manner to a flange-type coupler 2. An electromagnetic window 3 is hermetically sealed into a plate-like body 4 leaving two opposed mutually parallel surfaces 31 and 32 of the window exposed at opposite sides of the body 4. This body 4 is provided with inlet and outlet connections 5 and 6 for coolant fluid. The body 4 also contains holes 7 which align with corresponding holes 8 in the coupler 2 to bring the window 3 into alignment with the internal space of the waveguide 1. A seal 9 is interposed between the coupler 2 and the body 4 to surround the window 3 and thus prevent the escape of pressurising gas from within the waveguide 1.

The combined body 4 and window 3 may be sandwiched between two similar couplers 2 of two sections of waveguide, the whole assembly being held together by bolts 10 inserted through the holes 7 and 8. It will be appreciated however that the window could equally well be interposed in similar manner between the waveguide and an input or output device such as a microwave generator, an antenna or an oven, in order to isolate the internal environment within the waveguide from that of the device.

At this point it should be noted that the peripheral shape of the window 3 will depend upon the application. The shape of the window will normally be chosen to produce a minimum of reflected power and will depend on factors such as the effective dielectric constant of the window material and the required bandwidth of the window.

Referring now to FIGS. 2 and 3, it will be observed that when the window 3 is viewed in transverse section normal to its external surfaces 31 and 32 it can be seen to include a pair of continuous external layers 33 and 34 and an intermediate porous layer 35. The continuous layers 33 and 34 provide the external surfaces 31 and 32 and are mutually parallel, but they are each relatively thin in relation to the overall thickness of the window. The bulk of the window is provided by the intermediate layer 35, the structure of which is shown in more detail in FIG. 4. This layer is formed by a reticulum 36 in the form of a single unitary structure containing a multiplicity of internal spaces which are all mutually interconnected to define a single inter-reticulate space 37 which constitutes about 80% of the volume of the intermediate layer. The reticulum 36 is firmly joined to the continuous layers 33 and 34 to form a bridging structure between them. The inter-reticular space 37 is completely enclosed by the external layers 33 and 34 which are impermeable both to the pressurising medium within the waveguide 1 and to a coolant medium which is circulated through the space 37 via the inlet and outlet connections 5 and 6. The window is completely sealed to the body 3 around the periphery of the window so that the only means of access to the space is via the inlet and outlet connections 5 and 6. The space 37 thus forms an enclosed flow path for the coolant, which may be a conventional gas or liquid coolant.

The window 3 is formed of a ceramic which is low loss with respect to r.f. or microwave energy, which has a high thermal conductivity, and which is able to withstand high temperatures. An example of a suitable ceramic is high purity alumina (A1203) or beryllia (BeO). The above-described window structure can be formed in a number of ways, one of which will now be described by way of example.

A mould is constructed with parallel water-absorbent end walls which are arranged to be movable towards each other, and water-repellent, non-water-absorbent side walls. The basic ceramic material is mixed with water to form a slip which is poured into the mould and left therein until the required amount of water has been absorbed by the end walls. The slip is then poured out of the mould to leave a deposit of the ceramic material on the end walls. These deposits will eventually form the impermeable layers 33 and 34. In order to form the intermediate porous layer 35 a plastics mesh is placed into the mould, and the end walls are urged together to compress the mesh by the required amount. Ceramic slip is then pumped into the mould until the interstices of the mesh have been completely filled with slip, following which the water component of the slip is slowly evaporated off. In order to remove the plastics filler the mould is then heated to a relatively high temperature to bum off the mesh and leave behind a ceramic reticulum which once occupied the interstices of the mesh. The resulting void which was previously occupied by the mesh now forms the inter-reticular space 37. The ceramic material is then fired using standard firing techniques so that the ceramic structure achieves its final density.

Instead of using a plastics mesh it is possible to use a plastics foam of the required density or foamed plastics beads of the required size.

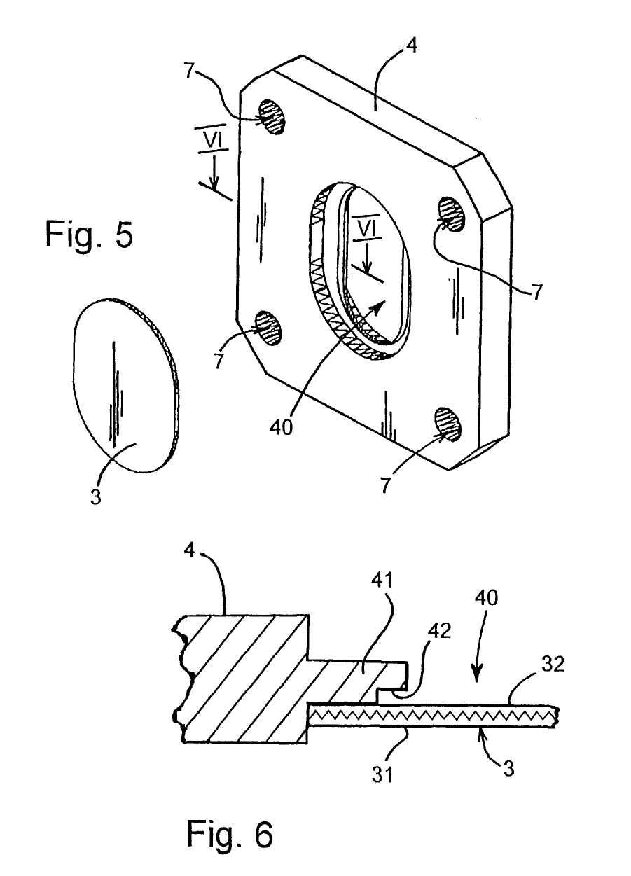

FIGS. 5 and 6 show further detail of a preferred high performance configuration for the window 3 and plate 4 (shown separated for illustrative purposes), from which the coolant connections 5 and 6 have been omitted for convenience. The window 3 is sealed into a correspondingly-shaped opening 40 in the plate 4, seated against an inwardly-directed flange 41. In the case of the oval-shaped window shown in the drawing (optimised for use with oval-section waveguide) the width of the flange 41 is greater along the straight edges of the opening than around the curved ends. In addition, it will be noted that the face of the flange 41 which is opposed to the adjacent face of the window 3 has a step-like peripheral recess 42 which extends along both of the straight sections of the flange 41, gently diminishing in width or disappearing altogether around the curved ends of the flange. The shape and depth of this recess can be optimised to improve the microwave performance of the window, providing improved VSWR across the operating frequency range. The window assembly is of simple construction yet has a higher performance and is more compact than existing assemblies.

In summary, the above-described window assembly exhibits a number of positive advantage over known window assemblies:

The flow of coolant through the inter-reticular space 37 very effectively cools the window since the effective contact surface area between the window and the coolant is very large. Since the interconnected voids of the space 37 are all randomly distributed and of different sizes the flow of coolant through the intermediate layer 35 is turbulent with few regions of stagnant or laminar flow. This permits the efficient mixing and distribution of the heat absorbed through the exposed surfaces of the window into the body of coolant and results in very high rates of heat extraction from the window material.

Since the majority of the window material is effectively immersed in coolant and each and every part of the window material is in exceedingly close proximity to a coolant flow a vary constant and accurately maintained temperature can be obtained by varying the flow rate.

Depending upon the coolant pressure and the external pressure of the window, the layers 33 and 34 can be made relatively thin yet still impermeable under all operating conditions. This results in a short distance between the closest cooling void of the space 37 and the outer surface 31 or 32 of the window. The cooling efficiency of the outer surfaces 31 and 32 are thus greatly enhanced.

Since the external layers 33 and 34 are rigidly interconnected by the reticulum 36 across the surface area of the window the window is very resistant to flexure and is able to withstand higher external pressures.

Any electrical discharge which starts up within the thickness of the window will be swept away with the flow of coolant material so that the effective path length is greatly increased, depending on the flow rate. This acts to suppress such discharges.

In the event that, at very high power levels, a rupture should occur in one of the outer layers 33 or 34 a flow of coolant will pass through it. This may act as a discharge suppressant to greatly reduce the chances of a discharge occurring across the rupture.

Any such rupture will also be prevented from propagating across the external surface of the window since the smooth curved surfaces of the voids of the space 37 act to reduce crack propagation.

It will be appreciated that the features disclosed herein may be present in any feasible combination. Whilst the above description lays emphasis on those areas which, in combination, are believed to be new, protection is claimed for any inventive combination of the features disclosed herein.

1. A transmission line window having a pair of opposed window surfaces (31, 32) through which electromagnetic energy passes in use, the window including a pair of mutually spaced layers (33, 34) between which there is a flow path for a liquid or gaseous coolant, said mutually spaced layers being impermeable to such coolant, and bridging material (35) extends between said layers in the coolant flow path in regions of the window which are disposed between the said window surfaces, characterised in that
the bridging material consists of or includes a solid reticulum containing numerous mutually interconnected internal spaces which are included in the flow path.

2. A transmission line window according to claim 1, in which the bridging material is integrally formed with said two mutually spaced layers (33, 34).

3. A transmission line window according to claim 1, in which the bridging material is formed of a ceramic.

4. A transmission line window according to claim 1, which is sealingly mounted in an opening (40) formed in a housing (4), in which the housing is provided with an inlet (5) and an outlet (6) for coolant which communicate with the flow path of the window, and the opening is provided with an inwardly-extending flange (41) in contact with one of the two mutually spaced layers (33, 34).

5. A transmission line window according to claim 4, in which the inner peripheral margin of the flange (41) has a recess (42) which is juxtaposed to the adjacent layer (34) of the window.

6. A transmission line window having a pair of opposed window surfaces (31, 32) through which electromagnetic energy passes in use and which is sealingly mounted in an opening (40) formed in a housing (4) characterised in that
the opening (40) is provided with an inwardly-extending flange (41) in contact with an adjacent one of the window surfaces (31, 32) and the inner peripheral margin of the flange (41) has a recess (42) which is juxtaposed to said adjacent window surface.
